(19) United States
(12) Patent Application Publication
(10) Pub. No.: US 2025/0149600 A1
(43) Pub. Date: May 8, 2025

(54) MIXED PLATINUM RUTHENIUM OXIDE AND ELECTRODES FOR THE OXYGEN EVOLUTION REACTION

(71) Applicant: BASF SE, Ludwigshafen Am Rhein (DE)

(72) Inventors: Daniel MALKO, Hannover (DE); Stefan KOTREL, Ludwigshafen am Rhein (DE); Sandip DE, Ludwigshafen am Rhein (DE); Lars MATTHES, Ludwigshafen am Rhein (DE); Ansgar SCHAEFER, Ludwigshafen am Rhein (DE); Sabine HIRTH, Ludwigshafen am Rhein (DE); Bernd HINRICHSEN, Ludwigshafen am Rhein (DE); Phillipp MUELLER, Ludwigshafen am Rhein (DE)

(21) Appl. No.: 18/730,647

(22) PCT Filed: Jan. 17, 2023
(86) PCT No.: PCT/EP2023/050933

§ 371 Date: Jul. 19, 2024

(30) Foreign Application Priority Data
Jan. 21, 2022 (EP) 22152720.3

(51) Int. Cl. H01M 4/90; C25B 1/04; C25B 11/093; H01M 8/10; H01M 8/18

(52) U.S. Cl. CPC H01M 4/9016; C25B 11/093; C25B 1/04; H01M 2008/1095; H01M 8/18

(57) ABSTRACT

A mixed metal oxide catalyst, particularly Pt and Ru containing oxide catalysts, based catalysts for polymer electrolyte membrane (PEM) fuel cells, water electrolysis, regenerative fuel cells (RFC) or oxygen generating electrodes in various electrolysis applications.

The present invention relates to a mixed metal oxide catalyst, particularly Pt and Ru containing oxide-based catalysts for polymer electrolyte membrane (PEM) fuel cells, water electrolysis, regenerative fuel cells (RFC) or oxygen generating electrodes in various electrolysis applications.

Hydrogen is a promising clean energy carrier that can be produced by various technologies. High-quality hydrogen can be produced by water electrolysis. As known to the skilled person, a water electrolyzer contains at least one anode-containing half cell where the oxygen evolution reaction (OER) takes place, and at least one cathode-containing half cell where the hydrogen evolution reaction (HER) takes place. If two or more cells are linked together, a stacked configuration is obtained. Accordingly, a water electrolyzer having a stacked configuration contains at least two anode-containing half cells and/or at least two cathode-containing half cells.

Different types of water electrolyzer are known.

In a PEM water electrolyzer, a solid polymer electrolyte is used which is responsible for proton transport from the anode to the cathode while electrically insulating the electrodes from each other, and for separating the product gases.

Due to its complexity, the oxygen evolution reaction has slow kinetics, which is why a significant overpotential is needed at the anode side for producing oxygen at reasonable rates. Typically, PEM water electrolyzers are operated at a voltage of about 1.5 to 2 V. As the pH is very acidic (PEM: pH of less than 2) and a high overpotential has to be applied, the materials which are present in the anode side of a PEM water electrolyzer need to be very corrosion resistant.

Typically, the anode of a water electrolyzer comprises a catalyst for the oxygen evolution reaction (an OER electrocatalyst). Appropriate OER electrocatalysts are known to the skilled person and have been described e. g. by M. Carmo et al., “A comprehensive review on PEM water electrolysis”, International Journal of Hydrogen Energy, Vol. 38, 2013, pp. 4901-4934; and H. Dau et al., “The Mechanism of Water Oxidation: From Electrolysis via Homogeneous to Biological Catalysis”, ChemCatChem, 2010, 2, pp. 724-761.

It is known that iridium or ruthenium oxides are efficient catalysts for the oxygen evolution reaction (EP 2 608 297 A1, Reier et al. Electrocatalytic Oxygen Evolution Reaction in Acidic Environments-Reaction Mechanisms and Catalysts. Adv. Energy Mater. 2017, 7, 1601275.).

However, iridium is poor in resources and expensive and ruthenium oxide has a minor stability neither singularly nor in form of an Pt—Ru-alloy. The limited resources of iridium will be a major obstacle for the roll out of PEM electrolysis technology. To expand the use of the electrolyzer, an anode made of a less expensive and abundant material is required.

As an alternative to iridium catalysts, some studies were made with platinum metal oxide using +1/+2/+3 ions like Li, Na, Mg, Ca, Zn, Cd, Co, Ni, Mn, Cu, Ag, Bi, In and Ce, wherein +1/+2 ions fit perfectly in the bronze structure.

EP 3 581 682 discloses an anode for electrolysis, comprising a homogenous platinum bronze MₓPt₃O₄ containing metallic element M, wherein the metallic element M is selected from the group of Mn, Co, Cu, Ag, Bi, and Ce. These anodes are inexpensive and excellent in duration and therefore a good alternative for Ir-anodes. However, the activity is still below those of Ir-anodes.

R. D. Shannon et al., Inorg. Chem., 21, 3372 (1982) discloses a method of synthesizing MxPt3O4 (M=Li, Na, Mg, Ca, Zn, Cd, Co, and Ni).

WO 03/005474 discloses an oxidation catalyst comprising metal oxide particles having the composition PdCoO2 or PtCoO2. US 2008/050640 discloses a catalyst comprising PtRuOx. US 2002/183200 discloses a platinum titanium carbon (PtTiOJC) catalyst, the mass percentage of Pt being 40 wt. %, and the atom ratio being Pt:Ti=5:1.

WO 2018/110423 describes the synthesis of platinum bronze, MxPt3O4, by mixing platinum oxide (PtO2) and the metal nitrate in a molar ratio of 3:1 obtaining MxPt3O4 and Pt. As metal nitrate Co, Ce, Ca, Li, Na, Bi, Ag, Cu, Mn and In were used. All metal nitrates were solids and were mixed with the platinum oxide using a mortar. In neither case was the metal nitrate brought in solution and impregnated on the platinum oxide. XRD analysis did not detect any other Pt phases besides MxPt3O4 (M=Co) phase.

Yim et al., International Journal of Hydrogen Energy 30 (2005) 1345, describes a preparation method for mixed PtRuOx materials by physically mixing Pt and RuOₓ to obtain an electrocatalyst with the appropriate composition. An inorganic Ru precursor was dissolved in deionized water, and the aqueous solution was then dried at 110° C. for 12 h and subsequently calcined in air at 400° C. for 5 h to form the oxidic phase.

Kamitaka et al. Catalysts 2018, 8, 258, discloses Co—Pt bonzes for electrocatalysis in acidic media.

Yi et al. discloses in “Effect of Pt introduced on Ru-based electrocatalyst for oxygen evolution activity and stability” (Electrochemistry Communications 104 (2019) 106469) a catalyst of a composition Ru₉Pt₁ which is deposited onto a carbon support. It is shown that the inclusion of Pt into the Ru structure can increase the stability of Ruthenium. However, the presence of a carbon support makes the material unsuitable for electrolysis applications due to the corrosive environment.

Other ruthenium or iridium containing compounds like phyrochlores and Perovskites were studied on OER activity (L. C. Seitz, C. F. Dickens, K. Nishio, Y. Hikita, J. Montoya, A. Doyle, C. Kirk, A. Vojvodic, H. Y. Hwang, J. K. Norskov und T. F. Jaramillo, “A highly active and stable IrOx/SrIrO3 catalyst for the oxygen evolution reaction,” Science, Bd. 353, p. 1011, 9 2016).

The object of the present invention is to provide a composition which is not based on iridium and which is iridium reduced or which does not contain iridium at all, and which is an effective electrocatalyst, in particular for the oxygen evolution reaction, showing high stability under very corrosive conditions (e. g. in PEM water electrolysis or PEM fuel cells), and is viable from an economical point of view.

### Invention

The catalyst composition comprises platinum and/or palladium (Pt/d) oxides and a transition metal (M) oxide that forms +4 ions, preferably wherein M=Cr, Ir, Mn, Si, V, Re, Nb, Ti, Sn, Pb and/or Ru, comprising at least two separate oxidic phases (i) a MO₂ phase and (ii) Meₓ(Pt/d)_{y}O₄ phase, wherein Me=M, Pt, Ca, Sr, Ba, Bi, Pd, Mn, Co, Cu, Ag, Ce, Mg, Zn, Cd, Co, Ni, Li, Na, and/or K and x=0.1 to 0.9 and y=2.7 to 3, wherein the particle size of the particles of the MO₂ phase is in the range of 5 nm (d10) and 70 nm (d90) and the particle size of the particles of the Meₓ(Pt/d)_{y}O₄ phase is in the range of 5 nm (d10) and 80 nm (d90) both measured by TEM particle size analysis.

Preferably Me stands for M, Pt, Pd, Sr, Bi, Na and/or K, more preferably for M, Pt, Na and/or K.

Preferably the MO₂ phase is a tetragonal phase. Preferably the Meₓ(Pt/d)_{y}O₄ phase is a cubic phase.

Preferably, the particle size of the particles of the MO₂ phase is in the range of 2 nm (d10) and 60 nm (d90), more preferably in the range of 7 nm (d10) and 50 nm (d90), even more preferably the range of 10 nm (d10) and 40 nm (d90) measured by TEM particle size analysis.

Preferably, all particles of the MO₂ phase have a particle size of below 100 nm measured by TEM particle size analysis.

Preferably, the particle size of the particles of the Meₓ(Pt/d)_{y}O₄ phase is in the range of 2 nm (d10) and 70 nm (d90), more preferably in the range of 7 nm (d10) and 60 nm (d90), even more preferably the range of 10 nm (d10) and 50 nm (d90), even more preferably the range of 15 nm (d10) and 50 nm (d90) measured by TEM particle size analysis.

Preferably, all particles of the Meₓ(Pt/d)_{y}O₄ phase have a particle size of below 100 nm measured by TEM particle size analysis.

Preferably the catalyst composition comprises platinum oxides and ruthenium oxide comprising at least two separate oxidic phases (i) a RuO2 phase and (ii) MexPt3yO4 phase. Preferably the Ru to Pt ratio is between 0.04 to 5, more preferably between 0.1 to 2, in particular between 0.4 to 0.7.

Preferably the catalyst composition exhibits a platinum peak with a binding energy of Pt 4f between 71 and 75 eV and a ruthenium peak with a binding energy of Ru 3d between 279 to 282 eV in an X-ray photoelectron spectroscopic (XPS) spectrum.

Preferably the binding energy gap between O1s and Ru3d is between 248.40 and 248.60 eV.

Preferably the binding energy gap between O1s and Ru3d is below 248.60 eV.

The present invention also includes a process including the steps of (a) mixing a predetermined amount of a raw material of platinum or palladium and transition metal (M) that forms +4 ions, (b) subjecting the raw material mixture to solid-phase reaction and (c) removing by-products from the resultant reactant, wherein the raw material of the transition metal that forms +4 ions is provided as a liquid solution.

The present invention demonstrates that the synthesis for platinum or palladium metal oxides using a second element that forms +4 ions does not result in a homogeneous bronze structure.

The present invention demonstrates that a material based on platinum and ruthenium shows a surprisingly high catalytic activity towards oxygen evolution reaction and is very stable under highly corrosive conditions. Ruthenium is 20 time more available than iridium. This will solve the iridium supply issue and allow large scale PEM electrolysis installations.

### Characterization of Catalyst

The term “composite catalyst” means that the catalyst contains of platinum or palladium oxides and of transition metal oxide that forms +4 ions and optionally elementary particles.

The catalyst composition contains as the transition metal (M) that forms +4 ions, preferably those transition metals (M) forming a tetragonal rutile grid like CrO2, IrO2, MnO2, SiO2, VO2, ReO2, NbO2, TiO2, SnO2, PbO2, RuO2, more preferably Ir, Sn, Re, Nb and/or Ru, in particular ruthenium.

The catalyst composition contains preferably platinum. The catalyst composition contains preferably both platinum and ruthenium.

In the following description, the term “platinum” is used for and includes both options platinum or palladium and the term “ruthenium” is used for and includes all transition metal oxides that forms +4 ions.

The atomic ratio of platinum to ruthenium may vary over a broad range. Typically, the atomic ratio between ruthenium to platinum is within the range of from 0.04 to 5, more preferably from 0.1 to 2, in particular 0.4 to 0.7.

Preferably, the total amount of platinum in the catalyst composition is within the range of from 30 to 99 wt %, more preferably from 40 to 98 wt %, more preferably from 50 to 97 wt %, more preferably from 60 to 96 wt %, more preferably from 65 to 95 wt %, more preferably from 70 to 95 wt %, in particular from 80 to 90 wt % relating to the total mass of the catalyst.

Preferably, the total amount of ruthenium in the composition is within the range of from 1 to 70 wt %, more preferably from 2 to 60 wt %, more preferably from 3 to 50 wt %, more preferably from 4 to 40 wt %, more preferably from 5 to 35 wt %, more preferably from 7 to 30 wt %, in particular from 10 to 20 wt % relating to the total mass of the catalyst.

Preferably, the catalyst composition contains Ca, Sr, Ba, Bi, Mn, Co, Cu, Ag, Ce, Mg, Zn, Cd, Co, Ni, Li, Na, and/or K, preferably alkaline metals, even more preferably Li, Na, and/or K, in particular sodium, in the range of 0.01 to 15 wt %, more preferably in the range of 0.02 to 10 wt %, more preferably in the range of 0.05 to 5 wt %, more preferably in the range of 0.1 to 4 wt %, more preferably in the range of 0.5 to 3 wt %, most favorably in the range of 1 wt % to 2 wt % relating to the total mass of the platinum precursor, e. g. PtO₂.

Preferably, the remaining amount up to 100 wt % is oxygen.

Preferably the catalyst composition contains 65 to 75 wt.-% platinum, 10 to 20 wt.-% ruthenium, 0.5 to 2 wt.-% alkaline metal, preferably sodium, and the remaining amount up to 100 wt.-% oxygen relating to the total mass of the catalyst.

The oxidation state of platinum and ruthenium can be verified by XPS.

Preferably, ruthenium is present in a in the oxidation state +IV as indicated by the Ru 3d signals in the XPS.

Preferably, platinum is present in a mixed valence state containing Pt atoms of oxidation state +IV and Pt atoms of oxidation state +II.

In addition, Pt in the oxidation state 0 and a polarized Pt species (“Pt (+δ)”) with a binding energy of the Pt 4f electrons in between the binding energy as expected from a Pt atom of the oxidation state 0 and +II as detected in a XPS measurement.

The exact binding energies for Pt 4f 7/2 and 5/2 signals can be taken from Table 1. The positions of all species but Pt (0) are given relative to the Pt (0) signal.

TABLE 1
Table with the binding energies of the different Pt signals

Binding Energy, eV (Δ to Pt(0))

| | Pt4f (7/2) | Pt4f (5/2) |
|---|---|---|
| Pt(0) | (71.0 eV +− 0.1 eV) | +3.3 |
| Pt(+δ) | +1 | +4.3 |
| Pt(II), type I | +1.4 | +4.7 |
| Pt(II), type II | +2.4 | +5.7 |
| Pt(IV) | +3.8 | +7.1 |

Preferably 2 to 30 at %, more preferably 3 to 20 at %, even more preferably 5 to 10 at % of platinum is present in oxidation state +IV.

Preferably 10 to 50 at %, more preferably 15 to 45 at %, even more preferably 30 to 40 at % of platinum is present in oxidation state +II. Preferably 5 to 30 at %, more preferably 10 to 25 at %, even more preferably 10 to 20 at % of platinum is present in oxidation state +II, Type I. Preferably 5 to 30 at %, more preferably 10 to 25 at %, even more preferably 10 to 20 at % of platinum is present in oxidation state +II, Type II.

Preferably 30 to 80 at %, more preferably 45 to 65 at %, even more preferably 55 to 60 at % of platinum is present in oxidation state (Pt (+8)). Preferably 0 to 15 at %, more preferably 0 to 10 at %, even more preferably 0 to 6 at % of platinum is present in oxidation state 0.

Preferably the platinum is present 5 at % to 10 at % in oxidation state +IV, 10 at % to 20 at % in oxidation state +II (type I), 10 at % to 20 at % in oxidation state +II (type II), 55 at % to 60 at % in oxidation state (Pt (+8)) and 0 at % to 8 at % in oxidation state 0.

Preferably 80 to 100 at %, more preferably 90 to 100 at %, even more preferably 95 to 100 at % of ruthenium is present in the oxidation state +IV, as indicated by the Ru 3d signals in the XPS. In particular all ruthenium is present in the oxidation state +IV.

The gap between the binding energy of O1s and Ru3d is preferably below 248.60 eV and, hence, ca.0.2 eV narrower than form non-inventive materials with similar composition.

The particle size of the Pt phase (Meₓ(Pt/d)_{y}O₄ phase) is preferably on average 10 to 60 nm, more preferably 20 to 50 nm, more preferably 20 to 40, more preferably 10 to 40, in particular 15 to 35 nm, as characterized by TEM measurements.

The particle size of the Ru phase is preferably on average 5 to 60 nm, more preferably 10 to 35 nm, more preferably 15 to 30 nm as characterized by TEM measurement.

The MexPtyO4 unit cell volume experiences some shrinkage and is preferably lower than 183 Å³ as measured with XRD. The MexPtyO4 cell volume is preferably between 181 and 183 Å³, more preferably between 181.5 and 183 Å³, even more preferably between 181.5 and 182.5 Å³. The XRD crystallite size of this Pt phase is below 20 nm. Preferably between 5 and 17 nm, more preferably between 10 and 15 nm, most preferably between 11 and 14 nm.

The shape of the particle is preferably spherical. Preferably the shape of the Pt particle is not cubical.

On a nanoscale, the platinum and ruthenium phases are preferably heterogeneously distributed. There are preferably distinct Pt and Ru rich regions that do not significantly mix. Platinum and ruthenium preferably reside in segregated regimes, but traces of platinum/ruthenium, up to 10 wt.-%, may be detected (incorporated) in the structure of the Ru/Pt phase and vice versa.

On a macroscale, these Ru and Pt rich regions/phases are homogeneously distributed.

Preferably, sodium is mostly, preferably above 80% of the total sodium content, present/associated within/with the Pt rich phase as characterized by TEM EDX.

Preferably, the catalyst composition comprises two phases
(i) A RuO₂ phase, preferably a tetragonal RuO2 phase
(ii) A MeₓPtyO₄ phase, preferably a cubic MeₓPt_{y}O4 phase, wherein Me=Ru, Pt and/or Na and x=0.1-0.9 and y=2.7-3.

Preferably, the ratio of the phase (i) RuO2 to (ii) MeₓPt_{y}O4 is between 0.02 to 5, preferably between 0.1 to 2, most preferably between 0.2 to 0.7.

The catalyst composition of the present invention has a BET surface area of from 5 to 200 m²/g, preferably 20 to 150, more preferred 30 to 100 m²/g.

### Support

Bulk catalysts may have a limited surface area for electrochemical activity. For increasing the catalytically active surface area, the catalyst composition might also be supported on a suitable carrier material. The carrier material is preferably an inorganic oxide, carbide or nitride material for example Antimony doped tin oxide (ATO), Titanium suboxides (TiO, Ti2O3, Ti3O5, and Ti4O7), TiC, ZrC, HfC, TaC, TiN, ZrN, HfN, TaN, Boron carbide, boron-oxy-carbide or boron carbides containing further elements such as boron silicon oxycarbide, more preferably TiO2, doped or undoped SnO2.

The present catalyst composition could also be used as a carrier material itself and be coated with additional catalytic material, e. g. with iridium.

### Process of Producing Catalyst

The ruthenium platinum oxide is obtained by:
(a) mixing a predetermined amount of a raw material of platinum or palladium and transition metal that forms +4 ions, preferably a predetermined amount of a raw material of ruthenium and platinum;
(b) subjecting the raw material mixture to solid-phase reaction under predetermined conditions; and
(c) removing by-products from the resultant reactant as required.
wherein the raw material of the transition metal that forms +4 ions is provided as a liquid solution.

### Mixing:

First, raw material of ruthenium and platinum are mixed. The platinum source is not specifically limited, examples of the platinum source include: platinum oxide (PtO2); and/or nitrate, chloro complexes, ammine salt, and hydroxy complexes of platinum, preferably PtO2. The platinum oxide may also contain sodium in the range of 0.1 wt. % to 5 wt. %, most preferably in the range of 1 wt. % to 2 wt. % relating to the total mass of the platinum oxide compound used. The ruthenium source is not specifically limited, examples of the metal source include: salt with inorganic anions such as nitrate, fluoride salt, chloride salt, bromide salt, iodide salt, carbonate, perchlorate, preferably nitrate.

The optimum mixing rate of ruthenium and platinum is selected according to the purpose and described above.

Preferably, a Pt precursor is used with a sodium amount of 0.1 wt % to 5 wt %. Sodium preferably alters the crystalline structure of the Pt precursor forming a stable Pt Ru oxide material during the thermal treatment step.

Preferably, the mixing is conducted to enable an intimate contact between the precursor resulting in a crucial interaction of the participating elements during the following thermal treatment step. The intimate contact can be achieved by optimizing the wetting.

Different mixing technique may result in different material properties. Mixing Pt and Ru precursors after the materials are individually temperature treated does not lead to an inventive a catalyst

The intimate mix of the precursor will lead to:
Less Pt leaching during a aqua regia (AR) treatment step
Little formation of elemental Pt (characterized by XRD) and the little formation of cubic shaped Pt particles (characterized by TEM)
Smaller Pt—and Ru-oxide particles (characterized by TEM)
Crystallite sizes of MeₓPt_{y}O₄ smaller than 20 nm and a shrinkage in unit cell volume to below 183 Å³
Changes in the ionization energies of Na1s, O1s, Ru3d with an ion energy gap between O1s and Ru3d of less than 248.6 eV (measured by XPS)
high electrochemical activity/stability

### Thermal Treatment:

Thereafter, the raw material mixture is subjected to solid-phase reaction. The reaction temperature is normally 500 to 800° C., preferably 550 to 750, more preferably 600 to 700° C. depending on the composition of the platinum ruthenium oxide. The reaction time is typically of the order of several minutes to several hours, preferably between 30 min and 12 h, in particular between 4 h and 8 h. As a liquid Ru precursor is used a drying step preferably precedes the solid-phase reaction. The drying temperature is preferably between 60 to 100° C., in particular between 70 to 90° C. Drying time is typically in the order of several minutes to several hours, preferably between 15 min and 2 h, in particularly between 20 to 40 min. Typically, the thermal treatment is carried out in an oxidizing atmosphere, such as air. In principle, an inert atmosphere can also be used.

Optionally, the thermal treatment can be repeated, e. g. for 1 to 4 times.

### Purification

The solid-phase product is already an electro-catalytically active and stable material. The byproducts, for example oxidizable Pt species, may then be optionally removed from the resultant reactant. The removal of the by-products is preferably performed by aqua regia treatment. Preferably the aqua regia treatment is conducted for 10 to 120 min and room temperature to the boiling point of aqua regia (108° C.), preferable 20 to 40 min at 70 to 90° C.

The resulting platinum ruthenium oxide is preferably filtrated to remove soluble components.

The leach of platinum upon aqua regia treatment is preferably in the region between 30 and 60% (see Table 5).

Finally, the platinum ruthenium oxide is optionally dried. The drying step is preferably conducted at a temperature of 70 to 90° C., a pressure of 50 to 1000 mbar and for 12 to 24 hours.

The final platinum ruthenium oxide might be subjected to a second, repeated thermal treatment.

### Manufacture of Anode/Applications

For manufacturing electrodes or catalyst-coated membranes, the catalyst composition can be processed into inks or pastes by adding suitable solvents. The catalyst ink may be deposited onto gas diffusion layers (GDLs), current collectors, membranes, or separator plates by commonly known deposition processes.

The present invention also relates to an electrochemical device, containing the catalyst composition as described above.

The electrochemical device can be an electrolyzer, in particular a water electrolyzer such as a PEM water electrolyzer; or a fuel cell such as a PEM fuel cell. It is also possible that the PEM fuel cell is a regenerative PEM fuel cell.

Like in any water electrolyzer, at least one anode-containing half cell where the oxygen evolution reaction takes place, and at least one cathode-containing half cell where the hydrogen evolution reaction takes place, are present in the PEM water electrolyzer of the present invention. The catalyst composition is present in the anode-containing half-cell.

According to a further aspect, the present invention relates to the use of the catalyst composition as described above as a catalyst for an oxygen evolution reaction (e.g., in an electrolyzer or a regenerative fuel cell or other electrochemical devices).

### Advantages

In contrast to prior art the described invention demonstrates a mixed platinum ruthenium oxide catalytic material with surprisingly high activity and stability (far greater than the individual binary oxides) for the electrochemical oxygen evolution reaction under acidic conditions. Surprisingly the beneficial mixing effect is demonstrated across a wide ratio of Pt/Ru. The present invention solves the problem of limited Ir supply by providing an alternative mixed oxide of Pt and Ru, which are elements with a significantly higher availability. In contrast to other reported Ru containing materials a higher stability is achieved. The mixed oxide is also significantly more active than recently reported Pt-Bronzes and it is shown that the material has distinctly different properties. The catalyst is demonstrated to have a commercially relevant activity under real operating conditions in a single PEM electrolysis cell.

Table 2 summarizes the features of this inventive catalyst and compares these features with features of materials with similar composition but lacking the advantage of the hereby described invention.

TABLE 2
Overview of inventive features and comparison
to non-inventive materials.

| | Inventive Material | Comparative example I and II |
|---|---|---|
| Electro- | High and stable activity | No activity |
| chemical | | |
| Activity | | |
| Appearance | Spherical particles and | Presence of rectangular Pt-rich |
| and general | well mixed at nano-scale | particles in case of example I |
| properties | Looses less than 60% of | Inhomogeneous and poorly |
| | Pt during aqua regia | mixed sample with PtO2 particle |
| | treatment | sizes up to 5000 nm |
| | | Both Materials lose more than |
| | | 60% of Pt during aqua regia |
| | | treatment |
| TEM | Pt and Ru rich particles | Average particle size at 60 nm |
| | smaller than 40 nm on | for comparative example I |
| | average | For comparative example II the |
| | | average particle size could not |
| | | be usefully calculated due to |
| | | the very inhomogeneous particle |
| | | size distribution and the partly |
| | | extremely large particles |
| XRD | Pt-oxide crystallites are | Pt-oxide crystallites are larger |
| | smaller than 25 nm | than 25 nm with a unit cell |
| | (mostly <15 nm) with a | volume larger than 184.0 |
| | unit cell volume smaller | Å³ for comparative |
| | than 182.5 Å³; | sample I |
| | Only equal or less than | Pt-oxide crystallites are larger |
| | 0.3 wt % of elemental Pt | than 30 nm for comparative |
| | is left after aqua regia | sample II. |
| | treatment | More than 2 wt % of Pt still be |
| | | present after aqua regia |
| | | treatment for comparative |
| | | sample I |
| XPS | Ionization energy for | |
| | Na1s and O1s is shifted | |
| | to lower energies by | |
| | 0.1 eV. | |
| | Ru3d, on the other hand, | |
| | is shifted to higher | |
| | energies by 0.1 eV. | |

### EXAMPLES

### Experimental Procedures

### 1. X-Ray Diffractograms of Powders

The samples were homogenized in a mortar and flattened into a sample holder and data collected on a Bruker AXS D8 Advance diffractometer using a copper anode running at 40 kv and 40 mA. The scan was run from 2° to 80° (2θ) using a step size of 0.02° (2 θ). Data was analyzed using TOPAS 6⁽¹⁾. Crystal structures of cubic Pt₃O₄⁽²⁾, tetragonal RuO₂⁽³⁾ and Platinum⁽⁴⁾ were used to create a model to simulate the powder diffraction pattern. Quantitative data were reported from the refined model. Crystallite size was reported using the integral breadth method (LVol-IB) as reported by TOPAS.

For the sample BRZ4-AR multiple variations of the basic structural model (2) were created to attempt to improve the fit of the computed diffraction pattern to the experimental data. The table below show the fit quality of models with Na, Ru and Pt at the unit cell origin. They show no discernable differences in the computed diffraction pattern. The quality is reported using the RBragg statistical value, which gives an understanding of the residual (R) of the experimental to the computed data pertaining to a single structure in a model containing multiple structures. This is reported in the TOPAS6⁽¹⁾ software. RBragg is defined as a residual, the cumulated misfit of the model in comparison to the experiment. RBragg values are given in %. The lower the RBragg values are, the better the model describes the experimental findings. It is clear that the models containing electron density at the origin of the unit cell (see first three entries of Table 1) do show better correspondence to the experimental data than the last entry of Table 1 at which this position is left unoccupied. A RBragg value lower by 3% indicates a statistically significant improvement. Hence, MexPtyO4 with Me=Na, Ru, Pt and x=0.1-0.9 and y=2.7-3. gives a better description of the structure than assuming a mere Pt₃O₄ phase.

TABLE 3
Comparison of RBragg values for different crystal structures
fitted to the diffraction patterns of BRZ-4-AR. Crystal structures
with an occupied position at the coordinates (0, 0, 0) show
a lower cumulative misfit (residual) by ca. 3% compared to
a Pt3O4 structure with unoccupied (0, 0, 0) position.

| Structure | RBragg, % |
|---|---|
| Na_{0.9}Pt_{2.7}O₄ | 5.2 |
| Ru_{0.1}Pt_{2.8}O₄ | 5.4 |
| Pt_{0.1}Pt₃O₄ | 5.3 |
| Pt₃O₄ ⁽⁵⁾ | 8.5 |

### LITERATURE

(1) TOPAS 6 User Manual, 2017, Bruker AXS GmbH. Karlsruhe, Germany
(2) B. Grande, Hk. Müller-Buschbaum, Ein Beitrag zu Verbindungen vom Typ Me x Pt 3 O 4, Journal of Inorganic and Nuclear Chemistry, Vol: 39, Issue: 6, 1084-1085 (1977). https://doi.org/10.1016/0022-1902 (77) 80270-4
(3) F. A. Cotton and J. T. Mague, The Crystal and Molecular Structure of Tetragonal Ruthenium Dioxide Inorganic Chemistry 1966 5 (2), 317-318 DOI: 10.1021/ic50036a037
(4) Albert W. Hull, X-Ray Crystal Analysis of Thirteen Common Metals, Phys. Rev. 17, 571-588, 1921
(5) Hector, A. L., Parkin, I. P. Solid state metathesis preparations of group VIII metal oxide powders. J Mater Sci Lett 13, 219-221 (1994). https://doi.org/10.1007/BF00278168

### 2. TEM Images and EDS Mapping

Powder samples were dispersed in ethanol and applied on an ultra-thin carbon-coated grid by the drop-on-grid-method. The samples were imaged by Transmission Electron Microscopy (TEM) using a probe-corrected Themis Z 3.1 machine (Thermo-Fisher, Waltham, USA) under different acquisition modes including High-Angle Annular Dark-Field (HAADF) Scanning Transmission Electron Microscopy (STEM), integrated Differential Phase Contrast (iDPC)-STEM, Bright-Field TEM and electron diffraction. The chemical composition was analyzed with the integrated SuperX G2 Energy-Dispersive X-Ray Spectroscopy (EDXS) detectors (Thermo-Fisher, Waltham, USA). Data was analyzed using the Velox 2.1x software (Thermo-Fisher, Waltham, USA). Particle size analysis was performed using the FIJI software tool (Schindelin, J., Arganda-Carreras, I., Frise, E., Kaynig, V., Longair, M., Pietzsch, T., Cardona, A. (2012). Fiji: an open-source platform for biological-image analysis. Nature Methods, 9 (7), 676-682. doi: 10.1038/nmeth.2019). Diffraction patterns were evaluated using Prodas software (Proscope, Gangelt, Germany, version: 1.4)

### 3. XPS

The XPS analyses were carried out with a Phi Versa Probe 5000 spectrometer using monochromatic Al Kα radiation. The XPS system is calibrated according to ISO 15472.2001. The BE (Binding Energy) of Au 4f7/2 is 84.00 eV and that of Cu2p3/2 is 932.62 eV.

All samples were mounted insulated against ground and neutralized in the course of the measurements with the built-in charge neutralizer and measured on three non-overlapping sample positions using a spot size of 0.1×1.4 mm (large area mode).

Survey scan analyses were carried out with a pass energy of 117.4 eV and an energy step size of 0.5 eV. High resolution analyses were carried out on the same analysis area with a pass energy of 23.5 eV and an energy step size of 0.1 eV.

Spectra have been charge corrected to the maximum of the Ru 3d-line that was RuO2 only and was therefore set to 280.6 eV.

All Spectra were analyzed using standard XPS-analysis software like CasaXPS (Fairley N, (2021). CASA-XPS, 2.3.50Rev1-0D, Casa Software Ltd) using Shirley background subtraction of the main peaks for the elements of interest. Relative sensitivity factors and transmission function as provided by the instrument manufacturer were used for quantification.

The Pt4f-Signal was fitted with five doublets having an energy separation of 3.3 eV using the following constraints and line shapes. The area of the Pt 4f 5/2 peaks was fixed at the area of 0.75 the area the Pt 4f 7/2 peak for all doublets. The metallic-parts of the Pt-Signal were fitted based on a natural line shape derived from the measurement of a pure metal reference (PtNULL-Lineshape).

The exact positions and FWHM and used Lineshapes are given in Table 4

TABLE 4
Exact line positions and FHWM of all Pt4f signals

| | Pt 4f 7/2 | | | | |
|---|---|---|---|---|---|
| | Position, eV | | Pt 4f 5/2 | | |
| | 71.0 +− 0.1 eV | FWHM | Position, | | Line Shape |
| Pt(0) | (Ref) | 1 | eV | FWHM | % &PT-NULL |
| Pt(+d) | 72.0 (Ref + 1) | 0.9 | 75.3 | 1.0 | LF(0.6, 1,200, 900) |
| Pt(II), type I | 72.4 (Ref + 1.4) | 1.2 | 75.7 | 1.05 | LF(0.6, 1,100, 900) |
| Pt(II), type II | 73.4 (Ref + 2.4) | 1.2 | 76.7 | 1.2 | LF(0.6, 1,200, 900) |
| Pt(IV) | 74.8 (Ref + 3.8) | 1.5 | 78.1 | 1.7 | LF(0.6, 1,200, 900) |

XPS measurement was performed for all Pt Ru oxide samples. The Ru 3d signals indicate the sole presence of RuO₂ (see FIG. 6).

### 4. Electrochemical Measurements

Experiments were conducted in 0.5M H₂SO₄ electrolyte at room temperature and under an atmosphere of argon. The catalyst was dispersed into H₂O/IPA 10/1 at 1 wt % to obtain an ink via ultrasonication, which was drop casted onto a gold electrode. All catalysts were deposited as to achieve the same total mass loading on the electrode as a thin film. The electrode was immersed into the electrolyte and the activity measured via linear sweep voltammetry in the potential range of 1.2 to 1.7 V versus the reversible hydrogen electrode (RHE).

### Preparation of the Examples

### Inventive Sample

A binary Platinum ruthenium oxide with platinum to ruthenium ratio of 3:1 was prepared following the method as depicted in FIG. 1a. The mixing was carried out by dripping Ru(NO)NO₃ solution from BASF Italia (Lot. No: 9002401825) with a Ru content of 18.8 wt. % onto the PtO₂ precursor by completely covering/wetting of the solid precursor. PtO₂ with a Na content of 1.6 wt % from Sigma Aldrich (Art. No. 206032) was used.

The PtO₂ impregnated with the Ru-containing solution was then ground to a fine powder. The powder was then dried and thermally treated using the following protocol.
1. Drying at 80° C. for 12 h
2. Heating up to 650° C. at 5K/min
3. Maintaining 650° C. for 6 h
4. Cool down (10 k/min)

After the thermal treatment, a part of the sample was treated with aqua regia at 80° C. for 30 min. The aqua regia treated sample was then again dried at 80° C. for 12 h. The composition of the resulting material was checked via atom emission spectrometry. Two samples were prepared following this procedure, BRZ-4-AR and H2-PEM-185. The preparation method for the INVENTIVE SAMPLES I is depicted in FIG. 1.a.

For one sample, the Ru/Pt ratios were measured before and after the aqua regia treatment.

The comparison of calculated and measured Ru/Pt ratios of Table 5 and the comparison of Ru/Pt ratios of non-aqua regia and aqua regia treated samples clearly shows that Pt is removed resulting in systematically higher Ru/Pt ratios.

TABLE 5
Impact of aqua regia treatment on Ru/Pt
ratio for the INVENTIVE SAMPLE

| | | | | Activity |
|---|---|---|---|---|
| | Ru/Pt; | Ru/Pt, | Loss | (I@1.6 V vs |
| | calculated | measured | of Pt | RHE in mA) |
| BRZ-4 (not AR leached) | 0.33 | 0.29 | 0 | 0.777 |
| BRZ-4-AR (leached) | 0.33 | 0.51 | 35% | 1.098 |

### Comparative Example I

For the first comparative examples PtO₂ and RuO₂ containing samples were prepared following the general preparation procedure as outlined by Yim et al. PtO₂ with a Na content of 1.6 wt % from Sigma Aldrich from Sigma Aldrich (Art. No. 206032) was used as the Pt containing material. Ru(NO)NO3 solution from BASF Italia (Lot. No: 9002401825) with a Ru content of 18.8 wt. % (as used in the inventive example) was used as the inorganic Ru precursor. This aqueous Ru solution was dried and thermally treated separately in the absence of the other metal precursor.

The following protocol was used:
1. Drying at 80° C. (drying was carried out in a vacuum drying oven and drying was extended until the solution has turned into a dried powder)
2. Heating up to 650° C. at 5K/min
3. Maintaining 650° C. for 6 h
4. Cool down (10 k/min)

The individually thermally treated samples were then physically mixed and ground to a fine powder. A portion of this material was subjected to the same aqua regia treatment as described in the INVENTIVE EXAMPLE. Two samples were prepared following this procedure. The preparation method for the COMPARATIVE SAMPLES I is depicted in FIG. 1.b.

For one sample, the Ru/Pt ratios were measured before and after the aqua regia treatment.

The resulting Ru/Pt ratio are given in Table 6. The Pt loss upon aqua regia treatment appears significantly higher than for the respective inventive sample with a comparable Ru/Pt ratio (see Table 5).

TABLE 6
Ru/Pt ratio for the COMPARATIVE EXAMPLE
I with and without aqua regia treatment

| | | | | Activity |
|---|---|---|---|---|
| | Ru/Pt; | Ru/Pt, | Loss | (I@1.6 V vs |
| | calculated | measured | of Pt | RHE in mA) |
| H2-PEM-192-1 | 0.33 | 0.33 | 0% | 0.101 |
| H2-PEM-192-2 | 0.33 | 0.93 | 64.5% | 0.307 |

### Comparison Example II

For a second comparative examples PtO2 and RuO2 containing samples were prepared following the general preparation procedure as outlined in WO 2018/110423. PtO₂ with a Na content of 1.6 wt % from Sigma Aldrich from Sigma Aldrich (Art. No. 206032) was used as the Pt containing material. Ru(NO)NO3 solution from BASF Italia (Lot. No: 9002401825) with a Ru content of 18.8 wt. % (as used in the inventive example) was used as the inorganic Ru precursor. This aqueous Ru solution was dried to a solid at 120° C. for 12 h and mixed with the platinum oxide using a mortar.

The following protocol was used:
1. Drying at 80° C. (drying was carried out in a vacuum drying oven and drying was extended until the solution has turned into a dried powder)
2. Heating up to 650° C. at 5K/min
3. Maintaining 650° C. for 6 h
4. Cool down (10 k/min)

This material was subjected to the same aqua regia treatment as described in the INVENTIVE EXAMPLE. The preparation method for the COMPARATIVE SAMPLE II is depicted in FIG. 1.c.

The resulting Ru/Pt ratio are given in Table 7. The Pt loss upon aqua regia treatment appears significantly higher than for the respective inventive sample with a comparable Ru/Pt ratio (see Table 5).

TABLE 7
Ru/Pt ratio for the COMPARATIVE EXAMPLE
II with and without aqua regia treatment

| | | | | Activity |
|---|---|---|---|---|
| | Ru/Pt; | Ru/Pt, | Loss | (I@1.6 V vs |
| | calculated | measured | of Pt | RHE in mA) |
| BRZ-33 | 0.33 | 2.86 | 88% | 0.312 |

### COMPARISON OF INVENTIVE AND COMPARATIVE EXAMPLES

### TEM

FIG. 2 depicts TEM image and elemental mapping EDXS for the INVENTIVE SAMPLE with a nominal Ru/Pt ratio of 0.33. On the nanoscale, there are clearly distinct Pt and Ru rich regions that do not significantly mix, while generally these Ru and Pt rich regions are homogeneously distributed, and the apparent particle size is well below 90 nm. Na is associated with the Pt rich particles.

Compared to the INVENTIVE SAMPLE, the Pt and Ru rich particles are not well mixed in the COMPARATIVE SAMPLE I (H2-PEM-192), and the Pt and Ru rich particles are on average double in size. As with the INVENTIVE SAMPLE Na is associated with Pt rich samples. SAED identifies a NaPt₃O₄ and Pt₃O₄, but also PtO₂ which was not detected for the INVENTIVE SAMPLE. When comparing the Pt and Ru particles, a different morphology is noticeable. While the Ru particles are often spherical structures, the Pt particles show more rectangular structures for the COMPARATIVE SAMPLE.

The COMPARATIVE EXAMPLE II does not hold any similarity to the INVENTIVE SAMPLE. The platinum ruthenium distribution is inhomogeneous and poorly mixed. The Ru oxide particles show a broad distribution in the range of 10 to 150 nm. The platinum oxide particles are in the range of 10 to 5000 nm.

FIG. 3 a) shows TEM images of the COMPARATIVE SAMPLE I after AR treatment. In contrast to the INVENTIVE SAMPLE, the Pt particles of COMPARATIVE SAMPLE I have a pronounced cubic shape. FIG. 3b) shows TEM Images of the COMPARATIVE SAMPLE II. Pt and Ru particles do not mix at all and often very large PtO₂ of up to 5000 nm can be spotted.

FIGS. 4 and 5 show box-plot representations and histograms of Pt-rich and Ru-rich particles from TEM particle size analysis of an INVENTIVE and COMPARATIVE SAMPLE I. In addition, Table 7 summarizes quantiles, mean and standard deviation for these samples. The INVENTIVE SAMPLE shows much smaller Pt- and Ru-rich particles with an average size of about 22 nm for Ru and of about 32 nm for Pt-rich particles. Particles of the COMPARATIVE SAMPLE have much larger particles with an average size of about 60 nm for Pt and of about 66 for Ru.

A generation of Box-plot representations and histograms of the Pt and Ru rich particles was not attempted due to statistically irrelevance caused by the very poorly mixed and inhomogeneous nature of COMPARATIVE SAMPLE II.

TABLE 8
Quantiles, mean and standard deviation for the TEM particle
size analysis for an INVENTIVE and a COMPARATIVE example.

| | # of | | | | | | | | | Std |
|---|---|---|---|---|---|---|---|---|---|---|
| | Particles | Minimum | 10% | 25% | Median | 75% | 90% | Maximum | Mean | Dev |
| | Ru-rich Particles | | | | | | | | | |
| COMPARATIVE(H2- | 86 | 22 | 37 | 48 | 59 | 68 | 83 | 112 | 60 | 18 |
| PEM-192-2) | | | | | | | | | | |
| INVENTIVE(H2- | 127 | 7 | 13 | 16 | 21 | 27 | 34 | 59 | 22 | 9 |
| PEM-185) | | | | | | | | | | |
| | Pt-rich Particles | | | | | | | | | |
| COMPARATIVE(H2- | 112 | 12 | 37 | 43 | 62 | 80 | 101 | 179 | 66 | 28 |
| PEM-192-2) | | | | | | | | | | |
| INVENTIVE(H2- | 164 | 9 | 20 | 24 | 31 | 39 | 47 | 62 | 32 | 10 |
| PEM-185) | | | | | | | | | | |

### XPS

XPS measurements were performed for the INVENTIVE and COMPARATIVE SAMPLE. Pt(+δ) appear to be somewhat less populated for the INVENTIVE SAMPLE (Table 8) than for the COMPARATIVE SAMPLE I (Table 9).

TABLE 9
Atomic percentages of the 5 Pt species found
in Pt 4f signals for the INVENTIVE SAMPLES

| | | | Pt(II), | Pt(II), | |
|---|---|---|---|---|---|
| | Pt (0) | Pt(+d) | type I | type II | Pt(IV) |
| BRZ-4-AR | 6.2 | 56.7 | 13.7 | 17.7 | 5.7 |
| H2-PEM-185 | 3.0 | 41.8 | 15.6 | 32.1 | 7.5 |

TABLE 10
Atomic percentages of the 5 Pt species found
in Pt 4f signals for the COMPARATIVE SAMPLE I

| | | | Pt(II), | Pt(II), | |
|---|---|---|---|---|---|
| | Pt (0) | Pt(+d) | type I | type II | Pt(IV) |
| H2-PEM-192-2 | 1.8 | 60.5 | 14.0 | 17.3 | 6.4 |
| H2-PEM-194-2 (w/AR) | 5.5 | 63.7 | 12.2 | 14.7 | 3.8 |

The peak positions of the detail spectra of Na1s, O1s and Ru3d were compared for the INVENTIVE and the COMPARATIVE SAMPLE I and COMPARATIVE SAMPLE II. For an exact analysis, the XPS spectra for all samples were shifted in such a way that the peak maxima in the range between 73 and 70 eV in the Pt 4f-Signal were superimposed at 72.00 eV. The O 1s spectra were fitted in such a way, that the peak maximum for Oxygen on Pt was at 529.8 eV and the Peak maximum for RuO2 was at 529.2 eV and allowed to shift within a limit of 0.2 eV around this value. The peak shape and width for both species was identical (0.9+−0.05 eV, symmetrical voigt line shape LA (1,1,900) in CasaXPS. Additional peaks for organic oxygen and adsorbed water were present but were not relevant. FIG. 6 shows the results of this comparison for the INVENTIVE SAMPLE and the COMPARATIVE SAMPLE I. Whereas the peak position of the Na1s signal is shifted to lower binding energy by 0.10 eV (Na 1s), the Oxygen contribution of the RuO2 shifts to higher binding energy by 0.15-0.20 eV (O 1s) for the inventive samples compared to the comparative samples. The Ru3d position is shifted to a higher binding energy by the around same extent (0.15+−0.05 eV) for the inventive samples compared to the comparative samples.

FIG. 7 provides the comparison of the INVENTIVE SAMPLE with the COMPARATIVE SAMPLE II. As with COMPARATIVE SAMPLE I the peak position of Na1s are shifted to lower binding energies by 0.1 eV and Ru 3d5/2 peak maximum is shifted to higher binding energies by 0.15 eV.

COMPARATIVE II exhibits a much higher relative amount of RuO2 than the other samples (Comparative and inventive alike) so far, hence the maximum of the O1s spectrum is dominated by the RuO2-Signal while the Pt—O-Signal is only slightly visible as a shoulder at ˜529.8 eV binding energy and therefore the overlay in FIG. 7 shows a very big difference in the position of the peak maxima, although the Pt—O-Signal does only shift by ˜0.1 eV.

Table 11 provides energy differences between O1s and Ru3d for INVENTIVE SAMPLES and COMPARATIVE SAMPLES. INVENTIVE SAMPLES show a consistent shift of the O1s and Ru 3d-Binding energy to higher values.

TABLE 11
Absolute Binding energies and Binding differences
between O1s (RuO2) and Ru3d for INVENTIVE
and COMPARATIVE SAMPLES I and II

| | RuO2 | RuO2 | Pt—O | | Delta(O1s |
|---|---|---|---|---|---|
| | (Ru3d) | (O1s) | (O1s) | Na 1s | (of RuO2)—Ru3d) |
| | eV B.E. | eV B.E. | eV B.E. | eV B.E. | eV |
| COMPARA- | 280.53 | 529.08 | 529.92 | 1069.70 | 248.55 |
| TIVE I | | | | | |
| 192-2 | | | | | |
| COMPARA- | 280.51 | 529.08 | 529.92 | 1069.66 | 248.57 |
| TIVE I | | | | | |
| 194-2 | | | | | |
| INVENTIVE | 280.70 | 529.31 | 529.88 | 1069.59 | 248.61 |
| BRZ-4-AR | | | | | |
| INVENTIVE | 280.64 | 529.25 | 529.86 | — | 248.61 |
| 185 | | | | | |
| COMPARA- | 280.55 | 529.10 | 529.76 | 1069.75 | 248.55 |
| TIVE II | | | | | |
| ref BRZ-33 | | | | | |

### XRD

The diffractograms of the samples mainly consist of two phases
(i) A tetragonal RuO₂ phase
(ii) A cubic MeₓPt_{y}O₄ for which a best fit could be obtained for Me=Ru, Pt, Na and x=0.1-0.9 and y=2.7-3.
(iii) Some residual elemental Pt, particularly for the comparative sample

Table 12 summarizes phase composition data and crystallite sizes from this analysis for the inventive and comparative examples. For sake of consistency, the platinum oxide phase was described using a cubic Pt₃O₄ structure, since this allows the comparison of unit cell volumes of the samples in a reliable fashion. On the other hand, determination and comparison of crystallite sizes and unit cell volumes are not affected by it in an appreciable manner. Obviously, the crystallite sizes Pt₃O₄ are much smaller for the inventive sample than for the comparative sample. Unit cell volume as calculated for the inventive samples is consistently lower than for the comparative samples by ca. 2 A3, but still higher than for a Pt3O4 crystallite unit cell (181 A3) (Russ. J. Inorg. Chem. (1971) 16, 1690-1693; Zh. Neorg. Khim. (1971) 16, 3190-3194). Only the comparative samples contain elemental Pt in a significant amount.

TABLE 12
Comparison of phase composition and crystallite
sizes for the inventive and comparative samples

| | | | | Unit | Crystallite |
|---|---|---|---|---|---|
| | | | | Cell | Size |
| | RuO₂ | Pt₃O₄ | Platinum | Volume | Pt₃O₄ |
| Sample | (mass %) | (mass %) | (mass %) | Pt₃O₄ (Å³) | (nm) |
| INVENTIVE | 26.1 | 73.7 | 0.2 | 182.1 | 13 |
| Brz4_ar | | | | | |
| INVENTIVE | 26.5 | 73.4 | 0.0 | 182.2 | 11 |
| 185 | | | | | |
| COMPARA- | 31.7 | 65.5 | 2.8 | 184.2 | 25 |
| TIVE I | | | | | |
| 192-2 | | | | | |
| COMPARA- | 32.5 | 64.9 | 2.7 | 184.0 | 24 |
| TIVE I | | | | | |
| 194-2 | | | | | |
| COMPARA- | 74 | 25 | None | 184.5 | 30 |
| TIVE II | | | | | |
| BRZ-33 | | | | | |

INVENTIVE EXAMPLES with varying Ru/Pt ratios were prepared following the method as described in FIG. 1. Table 12 summarizes the calculated and measured Ru/Pt ratios for these samples.

With increasing Ru content, drying the INVENTIVE EXAMPLES became more and more difficult and the dried material was starting to get very hygroscopic. Additionally, for the two samples with the highest Ru content (BRZ-6, BRZ-11) the Pt losses due to the aqua regia treatment increased to over 50%. No further samples with a Ru/Pt ratio above 5 were produced, since these samples would no longer be desirable, because of the given reasons.

TABLE 13
Calculated and measured Ru/Pt rations and
electrochemical activities for Pt Ru oxides

| | | | | Activity |
|---|---|---|---|---|
| | Ru/Pt; | Ru/Pt, | Loss | (I@1.6 V vs |
| | calculated | measured | of Pt | RHE) |
| BRZ-10 | 0.02 | 0.04 | 54% | 0.590 |
| BRZ-9 | 0.04 | 0.07 | 42% | 0.690 |
| BRZ-8 | 0.05 | 0.09 | 46% | 0.697 |
| BRZ-3 | 0.08 | 0.12 | 28% | 0.779 |
| BRZ-2 | 0.17 | 0.29 | 41% | 0.987 |
| BRZ-1 | 0.25 | 0.41 | 38% | 1.076 |
| BRZ-4-AR (leached) | 0.33 | 0.51 | 35% | 1.098 |
| BRZ-5 | 0.50 | 0.71 | 29% | 1.324 |
| BRZ-6 | 1.00 | 2.19 | 54% | 1.579 |
| BRZ-11 | 2.00 | 4.99 | 60% | 3.030 |

### XPS

For the Pt 4f signals 5 species could be detected and the atomic concentration of these species is given in Table 13. Consistent with the previous described INVENTIVE SAMPLE the surface concentration of the Pt (+δ) species mostly is below 60 at-%.

TABLE 14
Atomic percentages of the 5 Pt species found in Pt 4f signals for
Pt Ru Oxide where the Ru/Pt ratio was varied during the synthesis

| | Ru/Pt | | | | | |
|---|---|---|---|---|---|---|
| Sample | ratio, | | | Pt(II), | Pt(II), | |
| Name | measured | Pt (0) | Pt(+d) | type I | type II | Pt(IV) |
| BRZ-10 | 0.04 | 6.0 | 56.7 | 12.4 | 19.5 | 5.4 |
| BRZ-9 | 0.07 | 8.6 | 56.7 | 11.4 | 18.6 | 4.6 |
| BRZ-8 | 0.09 | 5.4 | 59.9 | 12.8 | 16.7 | 5.2 |
| BRZ-3 | 0.12 | 2.7 | 61.8 | 14.8 | 13.8 | 6.9 |
| BRZ-2 | 0.29 | 2.3 | 59.1 | 16.3 | 15.4 | 6.6 |
| BRZ-1 | 0.41 | 6.0 | 58.9 | 14.1 | 15.6 | 5.3 |
| BRZ-5 | 0.71 | 2.8 | 58.0 | 17.0 | 15.1 | 7.0 |
| BRZ-6 | 2.19 | 2.7 | 51.4 | 20.4 | 16.2 | 9.4 |
| BRZ-11 | 4.99 | 5.8 | 45.5 | 20.5 | 19.0 | 9.2 |

Table 14 summarizes the measured binding energy gap between O1s and Ru3d for these samples. In all cases this energy gap is narrower by ca. 0.2 eV than for the COMPARATIVE SAMPLES.

TABLE 15
Absolute Binding energies and Binding differences between O1s
(RuO2) and Ru3d for inventive samples with varying Ru to P

| | RuO2 | RuO2 | Pt—O | | Delta(O1s |
|---|---|---|---|---|---|
| | (Ru 3d) | (O1s) | (O1s) | Na 1s | (of RuO2)—Ru3d) |
| BRZ-9 | 280.56 | 529.51 | 529.89 | 1069.62 | 248.95 |
| BRZ-8 | 280.56 | 529.38 | 529.84 | 1069.57 | 248.82 |
| BRZ-3 | 280.52 | 529.3 | 529.7 | | 248.8 |
| BRZ-2 | 280.51 | 529.2 | 529.7 | | 248.6 |
| BRZ-1 | 280.63 | 529.21 | 529.85 | 1069.56 | 248.58 |
| BRZ-5 | 280.51 | 529.1 | 529.7 | | 248.6 |
| BRZ-6 | 280.47 | 529.1 | 529.7 | | 248.6 |
| BRZ-11 | 280.60 | 529.16 | 529.77 | 1069.58 | 248.55 |

### XRD

To illustrate the structural changes due to the variations of the Ru:Pt ratios the FIG. 7 shows the diffraction patterns of the varying ratios, starting from the first (bottommost) pattern with 0.037 Ru:Pt ratio, the next higher pattern shows the result of a 0.117 Ru:Pt ratio, the next 0.512, 2.192 and finally 4.998. The reflections of the first pattern show strong reflections of the MeₓPt_{y}O₄ phase with some minor contribution of the RuO₂ phase. With increasing Ru/Pt ratios those reflections become weaker and those of tetragonal RuO2 more become dominant.

Table 15 summarizes crystallite sizes MeₓPt_{y}O₄ (calculated based on a cubic Pt₃O₄ structure) of theses samples. The resulting crystallite sizes and cell volumes for all samples are consistent with previously described results for the INVENTIVE SAMPLE (cell volumes <183 Å³; Pt₃O₄ size <20 nm) and different from the results obtained from the COMPARATIVE SAMPLES (cell volumes >184 Å³; Pt₃O₄ size >20 nm). Table 144 also states the calculated relative concentration for RuO₂, Pt₃O₄ and Pt as derived from the fit. In neither case more than 0.4 wt. % of elemental Pt was found.

TABLE 16
Crystallite sizes and Pt₃O₄ Cell volume for
INVENTIVE SAMPLE with varying Ru/Pt ratios

| | | | | Ru/Pt | | Pt₃O₄ |
|---|---|---|---|---|---|---|
| Sample | RuO2, | Pt3O4, | Pt, | ratio, | Pt₃O₄ Cell | crystallite |
| Name | wt. % | wt. % | wt. % | measured | volume, Å³ | size, nm |
| BRZ-10 | 1.4 | 98.5 | 0.1 | 0.037 | 182.9 | 16.7 |
| BRZ-9 | 3.2 | 96.7 | 0.1 | 0.066 | 182.6 | 15.5 |
| BRZ-8 | 4.9 | 95.0 | 0.0 | 0.093 | 182.4 | 14.5 |
| Brz-3 | 6.7 | 93.2 | 0.1 | 0.117 | 182.4 | 13.6 |
| Brz-2 | 14.2 | 85.4 | 0.3 | 0.29 | 182.4 | 11.8 |
| Brz-1 | 25.2 | 74.7 | 0.1 | 0.406 | 182.3 | 11.8 |
| Brz-5 | 34.2 | 65.7 | 0.1 | 0.702 | 182.2 | 11.0 |
| Brz-6 | 56.1 | 43.7 | 0.2 | 2.192 | 182.1 | 10.7 |
| Brz-11 | 77.1 | 22.5 | 0.4 | 4.988 | 182.0 | 9.3 |

### Electrochemical Activity of Inventive and Comparative Examples

### a.) Electrochemical Activity

A comparison of the present INVENTIVE SAMPLE (BRZ4-AR) to Pt Bronze catalysts as described by Kamitaka et al. and to commercially available IrO2 (Alfa Aesar) (see FIG. 9) shows that the present INVENTIVE SAMPLE has a higher activity as compared to various Pt bronze materials and a comparable activity to IrO₂. Experiments were conducted in 0.5M H2SO4 electrolyte at room temperature and under an atmosphere of argon. The catalyst was dispersed into H2O/IPA 10/1 at 1 wt % to obtain an ink via ultrasonication, which was drop casted onto a gold electrode. All catalysts were deposited as to achieve the same total mass loading on the electrode as a thin film. The electrode was immersed into the electrolyte and the activity measured via linear sweep voltammetry in the potential range of 1.2 to 1.7V versus the reversible hydrogen electrode (RHE).

### b) Electrochemical Cycle to Cycle Stability

A comparison of the INVENTIVE SAMPLE (BRZ4-AR) to RuO2 (Alfa Aesar), utilizing the methodology described in a, (see FIG. 10) shows that while conventional RuO2 has a very high initial activity, when cycling the material between 1.2 and 1.7 V vs RHE for numerous cycles, the activity is lost quickly and completely vanishes after 30 cycles (see FIG. 10a), while activity of the INVENTIVE SAMPLE is completely retained (see FIG. 10b).

### c) Electrochemical Activity

A comparison of the INVENTIVE SAMPLE (BRZ4-AR) with a non-inventive Comparative Example I (H2-PEM-192-1) and Comparative Example II (BRZ 33) (see FIG. 11), utilizing the methodology described in 5.1, shows that a significantly higher activity is obtained by the inventive Example.

d) Activity of Inventive Examples with Varying Ru/Pt Ratios

A relation of activity and Ru amount (see FIG. 12 and Table 11) shows that the activity is retained over a wide range of Ru/Pt contents (shown in FIG. 12 as measured ratios), while in general a higher Ru content leads to a higher activity, albeit in a logarithmic relationship with potential. Hence, this allows the flexible preparation of the material according to the required application by adjusting the Ru/Pt content as required. At very low Ru loading and completely devoid of Ru (treatment with HNO3) the activity reaches a limit activity compatible to NaPtBronze.

### e) Stability Test

FIG. 13 shows the present INVENTIVE SAMPLE in comparison to commercial Ir black in a PEM Electrolysis single cell according to the procedure and conditions described below at a constant current of 0.5 A cm⁻².

f) Polarization curves of a catalyst coated membrane (CCM) in a single cell (25 cm2) Comparison of INVENTIVE SAMPLE (˜3.8 mg/cm⁻²) with a commercial Ir Black CCM (2 mg cm⁻², Quintech) and PtBi-Bronze (˜3.9 mg/cm²) (see FIG. 14) at 60° C. as outlined in WO 2018/110423. The catalyst coated membrane was prepared by spray coating a respective ink (5 g water, 0.1 g Nafion 5% solution in lower alcohols, 40 mg catalyst) of PtBi-Bronze or INVENTIVE SAMPLE onto a commercial Nafion117 membrane, which was coated on the cathode side with Pt/C at 1 mg/cm_{Pt} (Quintech GmbH) while maintaining the substrate on which the CCM was located at 60° C. The homogenous dried catalyst coated membrane was then processed through a calendar roll at 130° C.

g) Polarization curves of the same CCM with an INVENTIVE SAMPLE anode, directly after activation procedure and after approximately 1 week of constant operation (see FIG. 15) show that there is no discernible degradation taking place within the INVENTIVE SAMPLE.

### FIGURES

FIG. 1: Schema of the preparation procedure for the INVENTIVE (a), the COMPARATIVE SAMPLE I (b) and the COMPARATIVE SAMPLE II (c)

FIG. 2: TEM image and elemental mapping for the INVENTIVE SAMPLE with a nominal Ru/Pt ratio of 0.33

FIG. 3: TEM images and elemental mapping for the a) COMPARATIVE SAMPLE I and b) COMPARATIVE SAMPLE II both with a nominal Ru/Pt ration of 0.33.

FIG. 4: Box-plot representations and histograms of Ru-rich particles from TEM particle size analysis of an INVENTIVE SAMPLE and a COMPARATIVE SAMPLE I

FIG. 5: Box-plot representations and histograms of Pt-rich particles from TEM particle size analysis of an INVENTIVE SAMPLE and a COMPARATIVE SAMPLE I

FIG. 6: XPS spectra of the Na1s (FIG. 6a), O1s (FIG. 6b), Pt4f (FIG. 6c), and Ru3d (FIG. 6d) of INVENTIVE and the COMPARATIVE SAMPLES I

FIG. 7: XPS spectra of the Na1s (FIG. 7a), O1s (FIG. 7b), Pt4f (FIG. 7c), and Ru3d (FIG. 7d) of INVENTIVE and the COMPARATIVE SAMPLE II

FIG. 8: Diffraction patterns of INVENTIVE SAMPLES with varying Ru to Pt ratios.

FIG. 9: Comparison of electrochemical activity the INVENTIVE SAMPLE against Pt bronze (as described by Kamitaka et al) and IrO2.

FIG. 10: Electrochemical cycle to cycle stability of the a) INVENTIVE SAMPLE against b) RuO2

FIG. 11: Electrochemical activity of the INVENTIVE SAMPLE compared against the COMPARATIVE SAMPLE I (H2-PEM-192-2) and COMPARATIVE SAMPLE II (BRZ-33)

FIG. 12: Electrochemical activity of INVENTIVE SAMPLES with varying Ru/Pt ratios

FIG. 13: Stability of the INVENTIVE SAMPLE I comparison to Ir black in a PEM Electrolysis single cell

FIG. 14: Polarization curves of an INVENTIVE SAMPLE, a PtBi-Bronze and Ir black.

FIG. 15: Polarization curve of an INVENTIVE SAMPLE shortly after the begin of operation and after one week

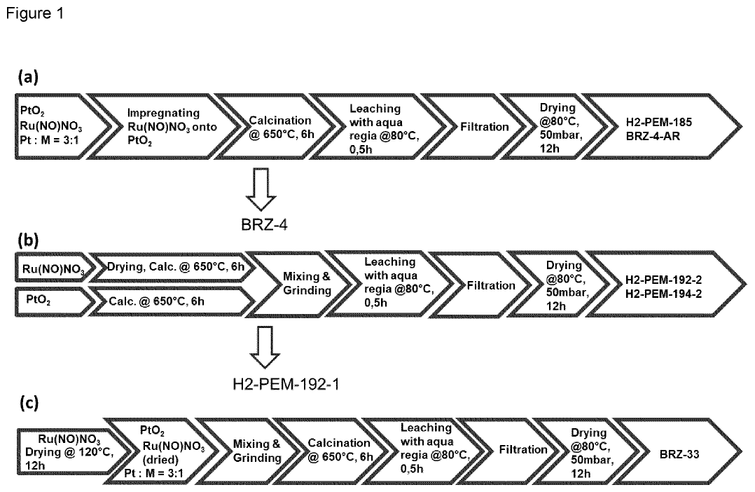

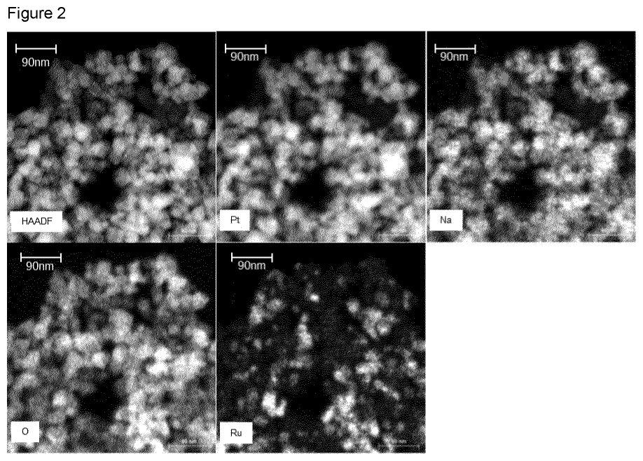

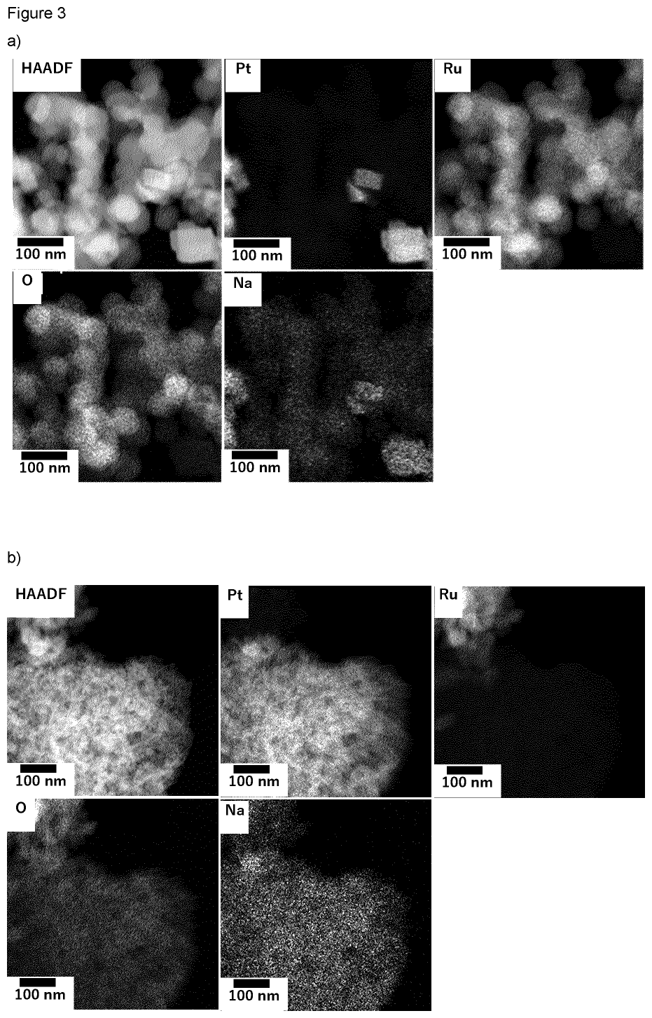

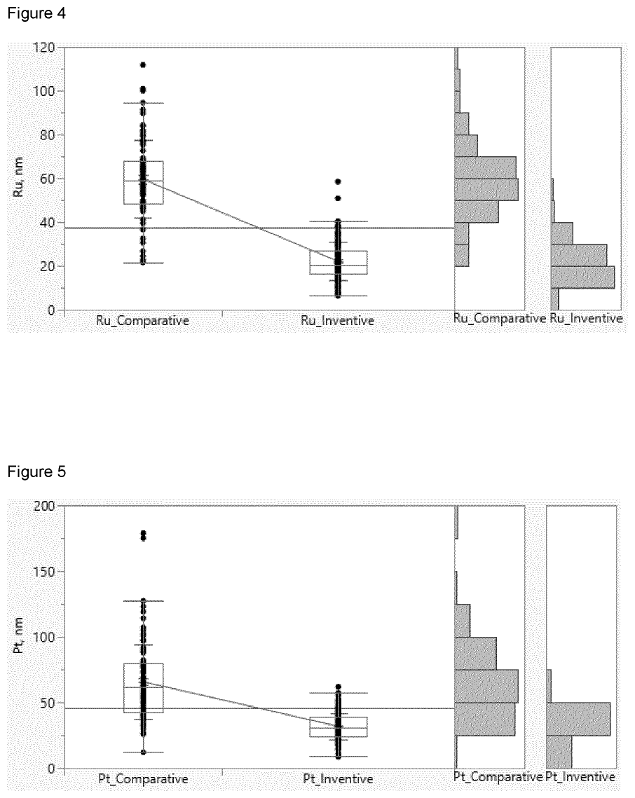

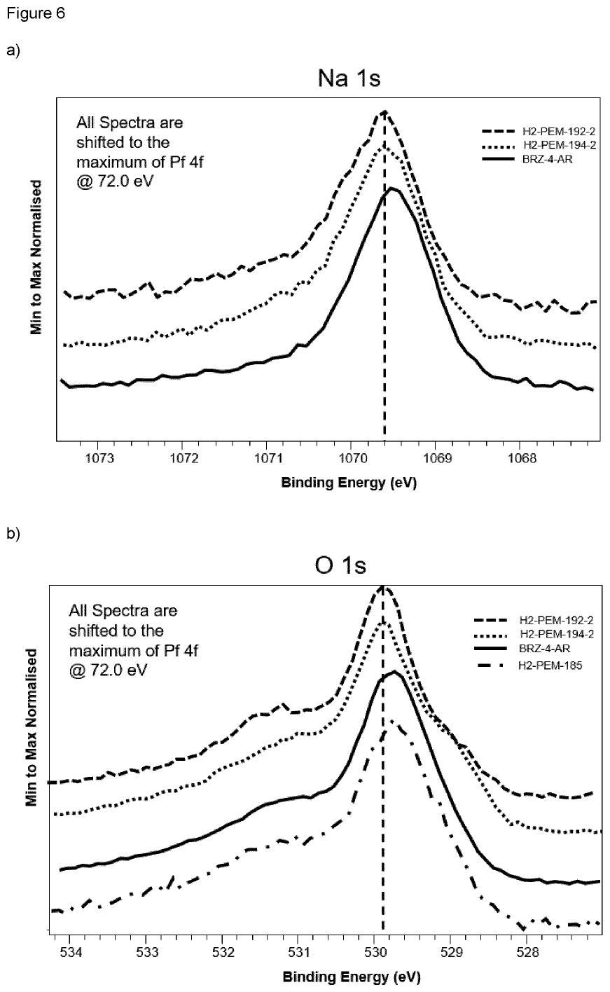

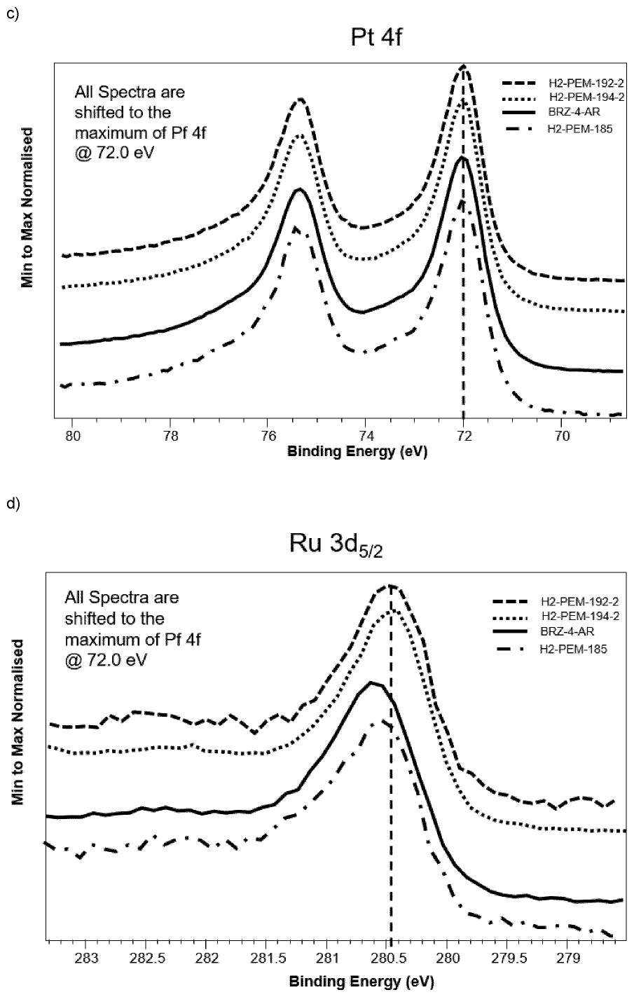

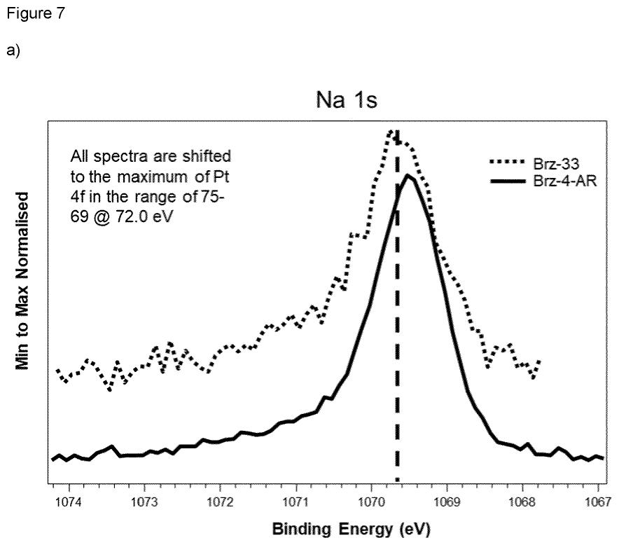

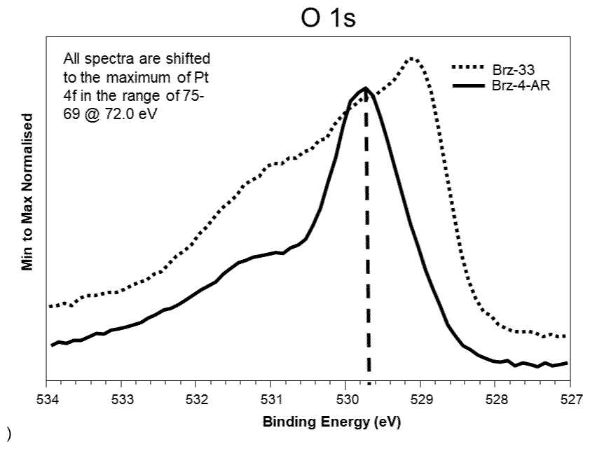

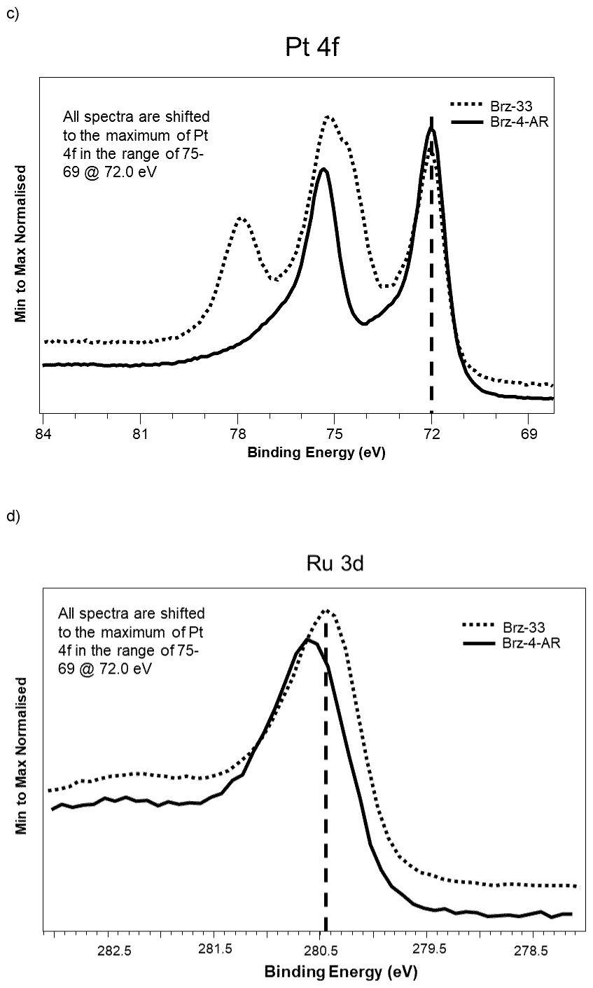

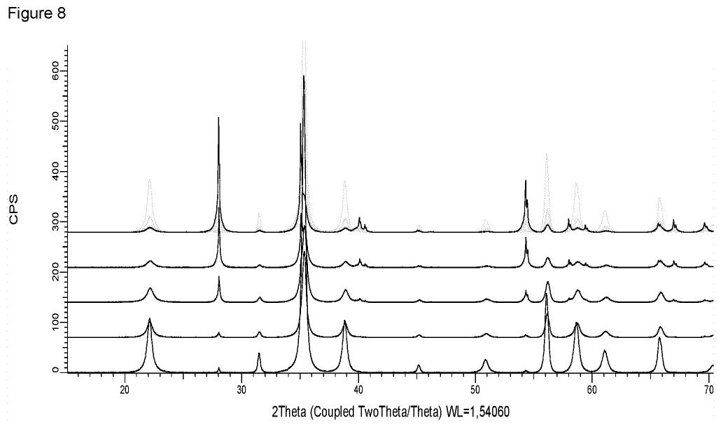

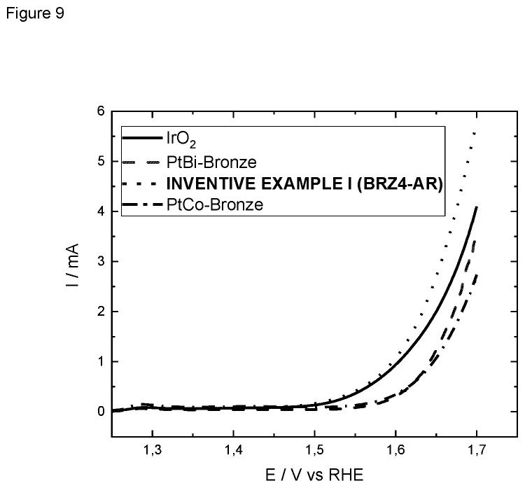

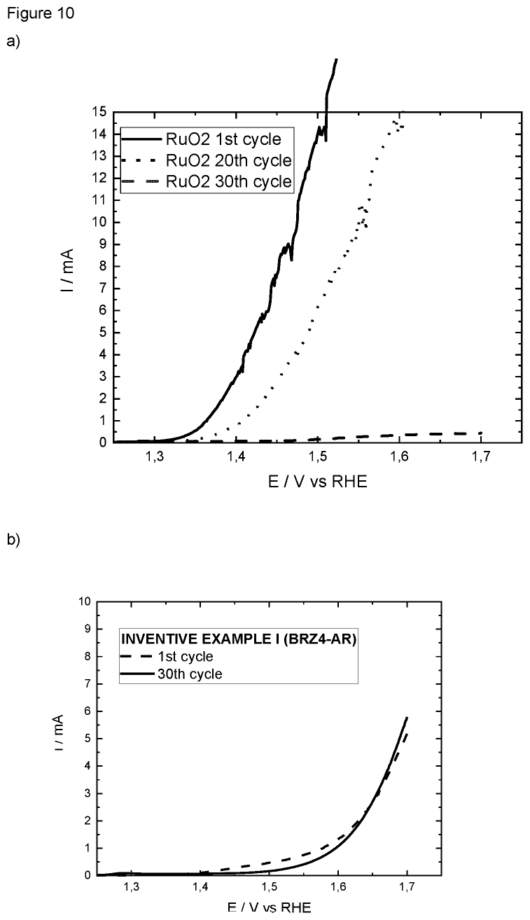

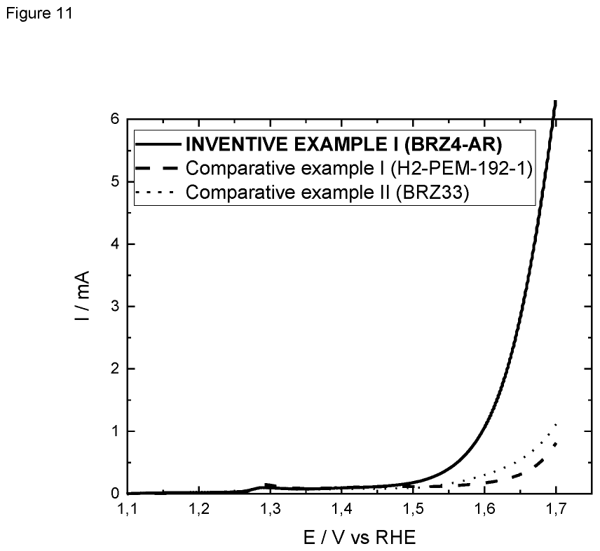

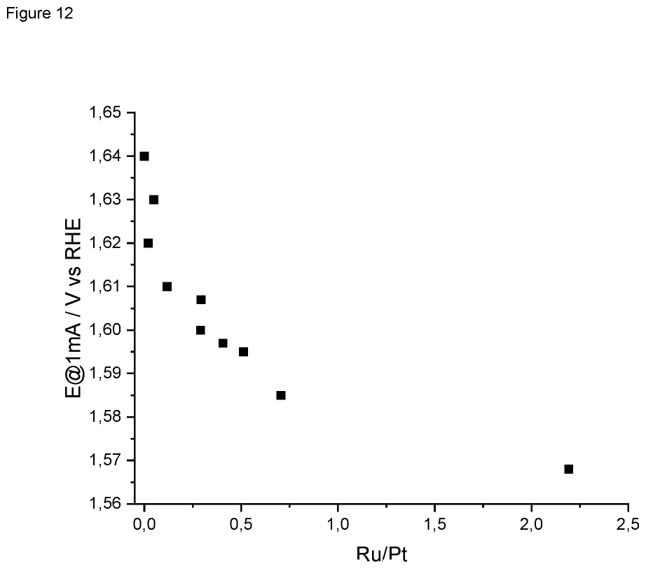

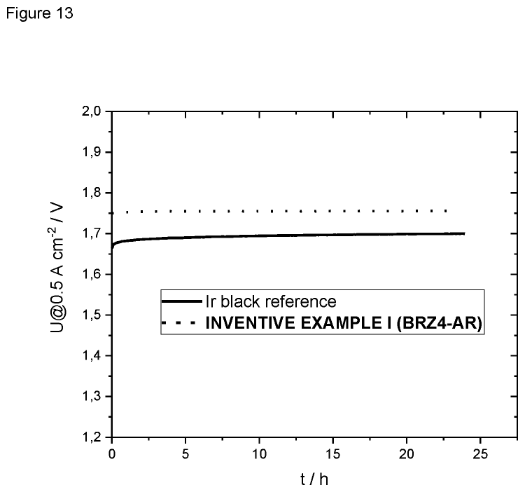

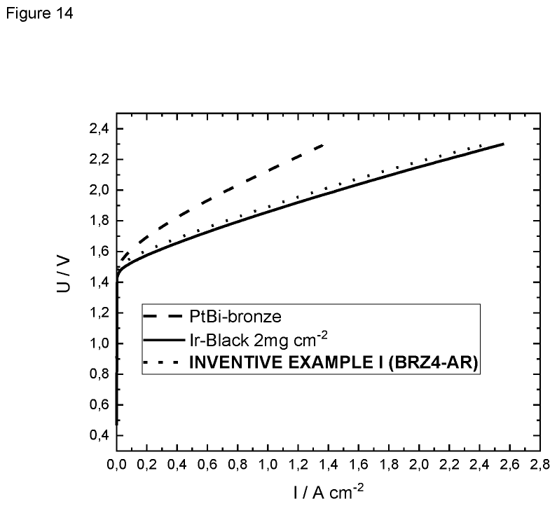

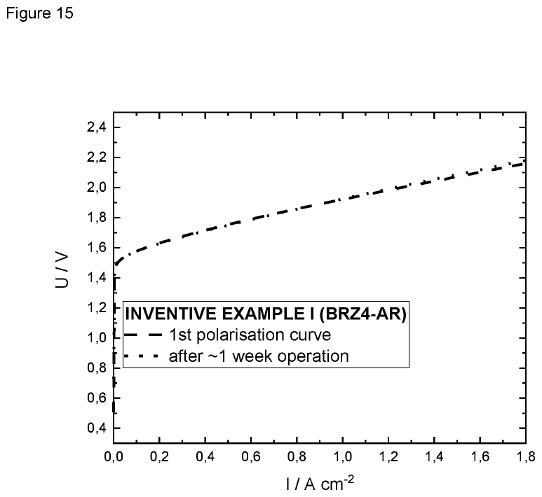

1. Catalyst composition comprising platinum and/or palladium (Pt/d) oxides and a transition metal (M) oxide, wherein M=Cr, Ir, Mn, Si, V, Re, Nb, Ti, Sn, Pb and/or Ru, comprising at least two separate oxidic phases (i) a MO₂ phase and (ii) Meₓ(Pt/d)_{y}O₄ phase, wherein Me=M, Pt, Na, and/or K and x=0.1 to 0.9 and y=2.7 to 3, wherein the particle size of the particles of the MO₂ phase is in the range of 5 nm (d10) and 70 nm (d90) and the particle size of the particles of the Meₓ(Pt/d)_{y}O₄ phase is in the range of 5 nm (d10) and 80 nm (d90) both measured by TEM particle size analysis,
wherein the catalyst composition comprises platinum oxides and ruthenium oxide comprising at least two separate oxidic phases (i) a RuO₂ phase and (ii) MexPt3yO₄, and
wherein the M to (Pt/d) ratio is between 0.04 and 5.

2. The catalyst composition according to claim 1, wherein the MO₂ phase is a tetragonal phase and the Meₓ(Pt/d)_{y}O₄ phase is a cubic phase.

3. A The catalyst composition according to claim 1, wherein on a nanoscale, the (i) a MO₂ phase and (ii) Meₓ(Pt/d)_{y}O₄ phase are heterogeneously distributed and on a macroscale, the (i) a MO₂ phase and (ii) Meₓ(Pt/d)_{y}O₄ phase are homogeneously distributed.

4. (canceled)

5. A The catalyst composition according to claim 1, wherein the catalyst composition contains Ca, Sr, Ba, Bi, Mn, Co, Cu, Ag, Ce, Mg, Zn, Cd, Co, Ni, Li, Na, and/or K in the range of 0.01 to 5 wt % relating to the total mass of the Pt or Pd precursor.

6. The catalyst composition according to claim 1, wherein the catalyst composition contains Li, Na, and/or K in the range of 0.01 to 5 wt % relating to the total mass of the Pt or Pd precursor.

7. The catalyst composition according to claim 1, wherein Li, Na, and/or K is associated with the Meₓ(Pt/d)_{y}O₄ phase.

8. (canceled)

9. The catalyst composition according to claim 1, wherein the Meₓ(Pt/d)_{y}O₄ cell volume is between 181 and 183 A³.

10. The catalyst composition according to claim 1, wherein the catalyst composition contains 65 to 75 wt.-% platinum, 10 to 20 wt.-% ruthenium, 1 to 2 wt.-% sodium and the remaining amount up to 100 wt.-% oxygen relating to the total mass of the catalyst.

11. The catalyst composition according to claim 1, wherein the catalyst composition exhibits a platinum peak with a binding energy of Pt 4f between 71 and 75 eV and a ruthenium peak with a binding energy of Ru 3d between 279 to 282 eV in an X-ray photoelectron spectroscopic (XPS) spectrum.

12. The catalyst composition according to claim 1, wherein the binding energy gap between O1s and Ru3d is between 248.40 and 248.60 eV.

13. The catalyst composition according to claim 1, wherein the particle size of the Pt phase is on average 10 to 60 nm and the particle size of the Ru phase is on average 5 to 60 nm as characterized by TEM measurement.

14. The catalyst composition according to claim 1, wherein the platinum is present 5 at % to 10 at % in oxidation state +IV, 10 at % to 20 at % in oxidation state +II (type I), 10 at % to 20 at % in oxidation state +II (type II), 55 at % to 60 at % in oxidation state (Pt (+8)) and 0 at % to 8 at % in oxidation state 0 and ruthenium is present 80 to 100 at % in oxidation state +IV.

15. A process for producing the catalyst of claim 1, the process including the steps of (a) mixing a predetermined amount of a raw material of platinum or palladium and transition metal (M), wherein M=Cr, Ir, Mn, Si, V, Re, Nb, Ti, Sn, Pb and/or Ru, (b) subjecting the raw material mixture to solid-phase reaction and (c) removing by-products from the resultant reactant, wherein the raw material of the transition metal (M) is provided as a liquid solution.

16. An electrochemical device, comprising the catalyst composition according to claim 1.

17. A use of the catalyst composition according to claim 1 as a catalyst for an oxygen evolution reaction.
